(19) United States
(12) Patent Application Publication
(10) Pub. No.: US 2019/0359330 A1
(43) Pub. Date: Nov. 28, 2019

(54) AIRBORNE SPACE ANTI-MISSILE SYSTEM

(71) Applicant: Superspace S&T Manufacture Co., Ltd, Hacienda Heights, CA (US)

(72) Inventor: Ligang Zhao, Hacienda Heights (CN)

(21) Appl. No.: 15/990,008

(22) Filed: May 25, 2018

(51) Int. Cl. B64D 1/06; B64C 30/00; B64C 3/40

(52) U.S. Cl. CPC B64D 1/06; B64C 3/40; B64C 30/00

(57) ABSTRACT

An airborne space anti-missile system provides an offensive anti-missile system that provides a supersonic jet flying in space at 10 times the speed of ultra-high speed jet to deliver air-to-surface missiles towards launch site of an attacking missile. The launching missile is targeted prior to launching or during flight. The supersonic jet comprises: a nuclear plasma jet engine operational in thermosphere, and a stamping jet fusion vector engine or anti-material vector engine for flying in lower atmospheres, no vertical tail and rudder, a pointed wing structure; a fuselage having a length of 60 meters and height of 15 meters, a variable swept wing configuration having a 100° range of wing positions, including a forward position where the wing is disposed forwardly, and wingspan is 200 meters from the fuselage, and a full rearward swept position where wingspan is 60 meters from the fuselage; and electromagnetic space for stealth operations.

### FIELD OF THE INVENTION

The present invention relates to airborne space anti-missile system that provides a unique and novel aerospace vehicle which can be based on the Earth as a base, or can be based on the Moon; though mainly based on the moon, flying on the edge of the atmosphere or in space, and is mainly used for anti-missiles.

The airborne space anti-missile system is tailored for future warfare and designed to destroy the three major weapons systems of future war.

The airborne space anti-missile system, its main function is to carry out three levels of “wearing a hat” model's vertical anti-ballistic missiles. First, the search and reconnaissance search destroys land-based missile launch bases and their carriers and support systems, sea-based missiles and their carriers. The second is to use an integrated reconnaissance search to destroy airborne missiles within 500 km above ground surface, with the focus on destroying supersonic glide missiles whose flight trajectory is on the Qian Xuesen trajectory, and intercontinental missiles of flying outside atmosphere.

Another function of the airborne space anti-missile system is to conduct an integrated search and reconnaissance on the enemy's space weapons to destroy or reverse control.

A further upgraded version of the airborne space anti-missile system will have the capability of destroying directed energy weapon systems.

The formation of the airborne space anti-missile system can be completed at the Earth base and sent into space via a heavy rocket.

The formation of the airborne space anti-missile system can also be completed at the moon base. After the key mature components are manufactured on the earth, they are sent to the moon base. Some of the components can also be generated on the moon base by intelligent 3D printing. Finally, the components are on the moon base, the intelligent assembly is completed so that it can better ensure the confidentiality and concealment of the airborne space anti-missile system. Under normal circumstances, the airborne space anti-missile system's flight base is located on the moon, that is, the anti-missile spacecraft only lands on the moon and does not fly and land on the earth.

The system enables an offensive anti-missile system that is partially operational in the thermosphere (space) that provides a supersonic jet that flies at 10 times the speed of an ultra-high speed jet flight to effectively deliver an air-to-surface missile from space towards the launch site (ground or sea) of an attacking missile; whereby the potentially launching missile is targeted prior to launching from a launch site or during flight; whereby the supersonic jet comprises: a nuclear plasma jet engine operational in the thermosphere, and a stamping jet fusion vector engine or an anti-material vector engine for flying in the lower atmospheres, no vertical tail and rudder, a pointed wing structure; a fuselage having a length of about 60 meters, a body height of about 15 meters, a variable swept wing configuration having a 100° range of wing positions, including a forward position where the wing is disposed forwardly, and the wingspan is about 200 meters from the fuselage, and a full rearward swept position where the wingspan is about 60 meters from the fuselage; and whereby the supersonic jet utilizes operates from seven attacking anti-missile modules, and also utilizes electromagnetic space for stealth operations—and further, the anti-missile supersonic jet can cruise on the edge of the Earth's atmosphere, can also fly to outer space, and also cruises through the atmosphere. The anti-missile supersonic jet will utilize its ramjet infused engine when it enters into the atmosphere and will utilize the “nuclear plasma engine” when it enters into the space. More advanced second-generation anti-missile airplane in the future will use a smaller anti-material injection vector engine, which, in theory, will allow the plane to cruise in space for up to 50 years.

The airborne space anti-missile system provides a primary function of carrying out three levels of cap style vertical anti-ballistic missiles. The first level includes a search and reconnaissance search destroys land-based missile launch bases and their carriers and support systems, sea-based missiles and their carriers.

The second level includes an integrated reconnaissance search to destroy airborne missiles within 500 km above ground surface, with the focus on destroying supersonic glide missiles whose flight trajectory is on the Qian Xuesen trajectory; Intercontinental missiles flying outside.

A third level of the airborne space anti-missile system is to conduct an integrated search and reconnaissance search on the enemy's space weapons to destroy or reverse control. The further combat improvement of airborne space anti-missile system is mainly the function of destroying the directed energy weapon system.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, flying vessels used for space travel, such as rockets and space shuttles, utilize chemical rocket engines to supply the thrust and acceleration needed to obtain and maintain earth orbit, moon landings, and interplanetary travel. Although rocket engines can produce very large amounts of force, the use of these chemical rocket engines imposes limitations on space travel due to fuel requirements. Such limitations create a desire for alternative propulsion methods for space travel. Often, space travel includes the use of expendable vehicles which begin a mission with all of the elements needed to complete the mission, and which lose mass through the consumption of fuel and the jettison of portions of the launch vehicles and exploration craft.

It is known in the art that a space-based anti-missile defense system can include a military space station that fuels Star Wars weapons, serves as a post to launch reconnaissance and battle missions, and act as a service station for space weapons. Operation in space is considered more efficient and stealth anti-missile solution than trying to accomplish these tasks than on the ground. Such a space-based missile defense system can include satellites, lasers, space-based missiles, radiation protection, high-pressure suits for military astronauts, as well as shields and other defenses to protect against the missile attacks and nuclear bombs anticipated to threaten both the space station and the ground target.

It is also known that a supersonic jet that operates in space can be difficult to detect from the ground. Such a supersonic aircraft generally breaks Mach 1, or the speed of sound, which at sea level is about 760 miles per hour (1,223 kilometers per hour). The supersonic aircraft is also known to be environmentally friendly on emissions, stable at subsonic speeds, reasonably affordable to operate, and able to fly on multiple anti-missile delivery missions without onerous maintenance.

Generally, an air-to-surface missile (ASM) or air-to-ground missile (AGM or ATGM) is a missile designed to be launched from military aircraft at targets on land or sea. There are also unpowered guided glide bombs not considered missiles. Typically, the higher and faster the launching aircraft is flying, the longer the reach of a particular missile is. For long-range missiles this difference can be relatively small, but short-range missiles have a much longer range when launched at altitude. It is known that various types of attack missiles pose a great threat to world peace and human security. This is especially true in regards to the air-to-air missile, which poses a fatal threat to the safety of airliners. This creates a missile threat to the peaceful life of civilians, so that in the attacking force of the missile is ubiquitous.

In fact, there is no good solution to the threat of empty missiles, and there are currently more mature ways to pass on attacking missiles. In the other side of the target of the target area of anti-missile missiles, passive to wait until the missiles quickly fell to their heads on the “bullet to bullet” negative defense. The problem of the actual operation of these methods is that the effect is poor, the efficiency is low, the risk is large, often cannot reach the purpose of solving the problem effectively. At the same time, the current missile defense systems only apply to the small, local attacking missile attack which solves the low intensity, strength and a wide range of attacking missile saturation attack. The current missile defense system is not only powerless, and the relevant anti-missile equipment itself cannot resist the high-density attacking missile saturation attacks that create myriad security problems.

It is typical to inquire the most efficient means to deliver anti-missile in the airspace of the front of the launch of the attacking missile, so that the attacking missile is directly destroyed in the head of the launcher, rather than in the head of the attacker's area. This is a problem that people have to face and solve the problem. It is necessary to destroy the air in the launch area of the attacking missile, according to the human end of the existing anti-missile method cannot solve this problem. The missile defense must use away from the attacking force to control the airspace of the space carrier timely anti-missile to achieve this problem.

Unfortunately, existing aircraft face the risk of entering the attacking territory to control the airspace in order to carry out the front side of the anti-missile, although far away from the attacking airspace of the satellite: Because of their own mobility and defensive capacity is still unable to protect themselves, simply cannot become a front. The airborne anti-missile carrier, and the existing aircraft and the satellite itself is the target set for air-to-air missile attacks. Therefore, the lack of specialized air space carrier to carry out the front of the anti-missile is the face of human problems.

Other proposals have involved anti-missile systems to destroy incoming missiles. The problem with these anti-missile systems is that they do not destroy the target prior to its launch. Also, the delivery means cannot infiltrate deep into enemy territory to deliver the anti-missile effectively. Even though the above cited anti-missile systems meet some of the needs of the market, an airborne space anti-missile system that provides a supersonic jet that delivers an anti-missile from the thermosphere (space) and that flies at 10 times the speed of an ultra-high speed jet flight to effectively deliver an air-to-surface missile from space towards the launch site (ground or sea) of an attacking missile and comprises: a nuclear plasma jet engine operational in the thermosphere, and a stamping jet fusion vector engine or an anti-material vector engine for flying in the lower atmospheres, and a variable swept wing configuration having a 100° range of wing positions, and also utilizes electromagnetic space for stealth operations, is still desired.

### SUMMARY

Illustrative embodiments of the disclosure are generally directed to an airborne space anti-missile system. The airborne space anti-missile system is offensive in nature, partially operational in the thermosphere (space), and partially operational from the lower atmospheres. The airborne space anti-missile system provides a supersonic jet that flies at 10 times the speed of an ultra-high speed jet flight to effectively deliver an air-to-surface missile from space towards the launch site (ground or sea) of an attacking missile. The potentially launching missile is targeted prior to launching from a launch site or during flight, so that it does not explode over a population center.

The anti-missile supersonic jet can cruise on the edge of the Earth's atmosphere, can also fly to outer space, and also cruises through the atmosphere. The anti-missile supersonic jet will utilize its ramjet infused engine when it enters into the atmosphere and will utilize the “nuclear plasma engine” when it enters into the space. More advanced second-generation anti-missile airplane in the future will use a smaller anti-material injection vector engine, which, in theory, will allow the supersonic jet to cruise in space for up to 50 years.

In some embodiments, the supersonic jet comprises: a nuclear plasma jet engine operational in space, and a stamping jet fusion vector engine or an anti-material vector engine for flying in the lower atmospheres, no vertical tail and rudder, a pointed wing structure; a fuselage having a length of about 60 meters, a body height of about 15 meters, a variable swept wing configuration having a 100° range of wing positions, including a forward position where the wing is disposed forwardly, such that the wingspan is about 200 meters, and a full rearward swept position where the wingspan is pulled in to reduce wind resistance and extends about 60 meters from the fuselage. Furthermore, the supersonic jet utilizes electromagnetic space for stealth operations.

Airborne space anti-missile system, its anti-missile feature is that the anti-missile attack system is started, which means that the intelligent anti-missile module optimizes system activation and enters the anti-missile module to decide the attack status. The anti-missile module is included seven anti-missile module: (1) Intelligent fly-surface ground attack module, (2) High-energy temperature and pressure cloud explosion anti-missile attack module in the atmosphere, (3) Intelligent smart high-speed stealth missile anti-missile module, (4) Tungsten-antimony alloy kinetic energy electromagnetic bomb anti-guiding ground attack module, (5) electromagnetic pulse anti-missile attack module, (6) outside the atmosphere ion gun anti-missile attack module, (7) super conductor laser system anti-missile attack module.

One objective of the present invention is to target and destroy an attacking missile prior to launching from the thermosphere (space).

Another objective is to operate the supersonic jet in the lower part of the thermosphere, about 100 kilometers above Earth, which is widely considered the boundary between the outer space and Earth's atmosphere.

Another objective is to carry an anti-missile on a supersonic jet that can evade missiles and penetrate an enemy region to deliver the anti-missile.

Yet another objective is to deliver anti-missile in the airspace of the front of the launch of the attacking missile, so that the attacking missile is directly destroyed in the head of the launcher, rather than in the head of the attacker's area.

Yet another objective is to retract the swept wing inward and rearward to reduce the air resistance during flight.

Yet another objective is to control the airspace in order to carry out the front side of the anti-missile problem.

Yet another objective is to enable the supersonic jet to fly at 10 times the speed of ultra-high-speed flight state, so as to avoid surface to air missiles.

Yet another objective is to provide various anti-missile modules to create intelligent operational conditions; and thereby eliminate the attacking missiles and/or the launch site.

Yet another objective is to target various types of attacking missiles and their carriers, whether being underground, on the ground surface ground, underwater, on the water, in the air, and in the thermosphere (space).

Yet another objective is to maintain the supersonic jet at a silent cruise flight, including the infrared wavelengths and a variety of adaptive wavelengths of the radar immediately activated to start intelligent integration detection.

Yet another objective is to effectively control the attacking missile deterrence of others attacking force, eliminate attacking missiles, be the guardian of human justice and democracy, help to free special space equipment, and be a strong cornerstone to defense.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

Airborne space anti-missile system, its anti-missile feature is that the anti-missile attack system is started, which means that the intelligent anti-missile module optimizes system activation and enters the anti-missile module to decide the attack status. The anti-missile module is included seven anti-missile module: (1) Intelligent fly-surface ground attack module, (2) High-energy temperature and pressure cloud explosion anti-missile attack module in the atmosphere, (3) Intelligent smart high-speed stealth missile anti-missile module, (4) Tungsten-antimony alloy kinetic energy electromagnetic bomb anti-guiding ground attack module, (5) electromagnetic pulse anti-missile attack module, (6) outside the atmosphere ion gun anti-missile attack module, (7) super conductor laser system anti-missile attack module, these seven kinds of anti-missile attack modules to build a full coverage anti-missile system, as follows:

Module One, the smart fly swarms surface attack module, the anti-missile mode is to carry out the destroy attack on the surface of the rogue missile launching position (including the vehicle-mounted missile), and its working mechanism is such that the smart flies are assembled in the mini In stealth missiles, under the guidance of the guidance and self-identification of the fly's eye system, from the anti-missile spacecraft, the mini stealth missiles secretly and accurately approach the target area. In the airspace near the surface of several hundred meters, the smart fly is removed from the mini. Invisible missiles are released.

In addition to the fly-eye pattern recognition capability, the smart fly has a more olfactory perception capability. The smart fly's olfactory ability is extraordinary. It can sensitively perceive the propellant of the missile propulsion department, and even the pharmacy of the warhead, the battery of the control unit, and can be summarized. The most essential are the five basic characteristics: Intelligent flight autonomous attack missiles, radar and the naked eye cannot effectively capture it, sensitive graphics and sense of smell (Intelligent Recognition Perception and Locking Missile Propelling Material System and Missile Warhead Material System), Carrying Chemical energy can be used to explode condensed explosives (in the future, it will be upgraded to micro nuclear bombs and then upgraded to anti-matter), and it will be irretrievably self-destructive (even if captured, it cannot be dismantled, i.e. exploded or exploded).

The first generation of smart flies mainly used the cluster attack mode. After entering the enemy missile position, the smart fly group, the intelligent identification group, flew to each enemy's missile body, and attacked the three key parts of the missile, that is, the target of the attack was the missile warhead., control department (including gyroscopes, computers, batteries, etc.), propellant propellants, etc.

The smart flies are attacked by a percussive attack. That is, the smart fly flies to the missile at high speed, and the missile immediately explodes on contact with the missile. It shows high efficiency and does not give any time to the enemy. The smart fly swarm will be different in this way. Angle launches a cluster suicide attack on the missile.

When a smart fly is found close to an enemy missile hiding in a cave or a missile silo and cannot perform a percussive attack, it has two choices: When it hides itself for a moment, it waits for opportunities to opportunistically attack. The second is to call antimissiles. Air-to-sky aircraft launches a tungsten-germanium alloy kinetic energy bomb that performs a destructive attack.

That is, the smart fly swarm surface attack module is mainly used for the anti-missile attack before the rogue missile launch. It is characterized by the most suitable surgical missile attack before launch.

Module II, the high-energy temperature and pressure cloud explosion anti-missile attack module in the atmosphere, namely the front-stage anti-missile module, mainly for medium-sized targets.

The block is mainly used in the instant of the rogue missile launch, that is, the anti-missile spacecraft discovers and locks the evil missile, and also locks the rogue missile launching platform, such as ground-based missile silos, launch vehicles, submarines, ships, and airplanes. The turbulent guided missile launching platform will launch high-energy, warm-pressure cloud-explosive bombs under the commanding heights and implement a vertical “cap shot” attack. The high-energy temperature-pressure cloud explosion bombs are divided into two levels. The first level enters the rogue missile trajectory climbing passage and instantly disengages and breaks up. Spray cloud explosives into aerosols with high concentrations of air clouds, densely covered with missiles in the ballistic region of the rogue missiles, rogue missiles passing through air masses, and tail flames detonating air masses. Rogue missiles must be completely destroyed; at the same time, high-energy temperature-pressure cloud explosions. The second level flies directly to the rogue missile launching platform. Its explosion effect can completely destroy all types of surface medium and small missile launching platform devices.

That is, the high-energy temperature and pressure cloud explosion anti-missile attack module in the atmosphere is suitable for front-stage anti-missile attacks. It is characterized by a clustered rogue missile that is most suitable for surface-type attack zones and belongs to a face-to-face carpet type saturation attack mode.

Module 3, intelligent smart high-speed invisible missile anti-missile module, intelligent smart ultra-high-speed stealth missile is an intelligent missile, specifically for the missed-flight missile to implement a locking attack.

When smart high-speed stealth missiles are put into operation, they will identify and intelligently lock in-flight hooligan missiles. When smart high-speed stealth missiles accurately lock rogue missiles, they will hit the rogue missiles at high speed, and the rogue missiles will be completely destroyed. At the same time, the smart and smart high-speed invisible missiles can also attack the mobile platforms formed by the missile's metal objects, such as warships, aircraft carriers, trains, trucks, and airplanes.

That is, the smart dexterity high-speed invisible missile anti-missile module can be used for both front-end anti-missile and mid-course anti-missile attacks.

Its characteristic is that it is most suitable for point-type precision attacks on scattered rogue missiles.

Its function is suitable for intercepting supersonic speed glide rogue missiles that destroy the flight trajectory on the Qian Xuesen trajectory.

Module IV, W—Ta—Hf alloy kinetic energy electromagnetic shell anti-guiding ground attack module, namely the front section anti-missile module, mainly for large targets. This module is mainly used in the instant of the rogue missile launch attack. That is, the anti-missile spacecraft discovered the large-scale rogue missile launch position group, followed by the rogue guided missile launch vehicle, launch base, launch cave, and other targets on the earth. Launched by an electromagnetic gun and accelerated by a secondary acceleration over 300 times of supersonic speed. The front end of W—Ta—Hf alloy kinetic energy electromagnetic cannon is a W—Ta—Hf alloy kinetic energy earth-drilling bomb that performs a vertical “cap shot” attack and high-speed kinetic energy drilling. The effect of impact bombing upon landing is exactly equivalent to the meteorite landing effect, which will produce high-temperature, high-heat blast shock waves, and will lead to local small earthquakes. All types of underground and surface flow missile launch positions and devices will be completely destroyed. At the same time, for the successful launching of a rogue missile, in the early stage of the missile's flight, that is, during the missile's climb phase, the electromagnetic gun again launches a kinetic warhead, which is bombarded with a high-altitude impact, destroyed during its climb-up phase, and completes the anti-missile at the front stage.

The W—Ta—Hf alloy kinetic energy electromagnetic shell anti-guiding ground attack module is mainly used for the front-stage anti-missile attack, which is characterized by the most suitable surface carpet type saturation attack.

Module 5, electromagnetic pulse anti-missile attack module, the middle anti-missile module, is mainly aimed at the rogue missile in flight. When the rogue missile slipped into the middle flight, the anti-missile spacecraft locked the rogue missile and used high-power electromagnetic pulses to accurately attack the flying rogue missile. The rogue missile's control system lines and chips were destroyed by electromagnetic pulses, i.e. rogue missiles. Failure was destroyed.

That is, the electromagnetic pulse anti-missile attack module can be used not only for front-end anti-missile attack, but also for middle-stage anti-missile attack. It is characterized in that it is suitable for point-type precision attack of scattered rogue missiles, and is also suitable for surface-saturation attack of grouped hooligan missiles.

Module 6, outside the atmospheric ion gun anti-missile attack module, the middle section anti-missile module, also known as space anti-missile mode, mainly for the missile in flight. Anti-missile air-to-sky planes collect unlimited ion “ammunition” from the solar wind. When the rogue missile enters outside the atmosphere, the anti-missile air-to-ground aircraft keeps the lock-up hooligan missile, and the ion guns use the high-energy ion beam to carry the in-flight rogue missile. With precision strikes, the huge kinetic energy of the ion beam and the transformed heat energy will make the rogue missile physically destroyed.

At the same time, the ion gun also specializes in attacking air-launched maneuvering platforms that launch rogue missiles, such as satellites, spacecraft, and space stations.

That is, the ion bombardment counterattack attack module outside the atmosphere is used for mid-course anti-missile attack. It is characterized by being suitable for point-type precision attack of scattered rogue missiles, as well as surface-saturation attack cluster hooligan missiles.

Its function is suitable for intercepting supersonic speed glide rogue missiles that destroy the flight trajectory on the Qian Xuesen trajectory.

Module VII. The anti-missile attack module of the superconducting laser system is mainly applicable to attacking and destroying ballistic missiles and Qian Xuesen's trajectory missiles outside the atmosphere. The working mechanism is that the superconducting laser system only needs to aim at the target missile and fire the laser at an instant, which can cause irreversible damage to the external structure of the missile. When the damaged missile re-enters the atmosphere, it is inevitably at high temperatures. Extend from the damage, it is destroyed by the height heat.

The superconducting laser system is made of superconducting materials and does not bring huge heat to the system, which can ensure stable operation of the laser weapon system and antimissile module.

That is, the superconducting laser system anti-missile attack module, which is mainly used for mid-course anti-missile attacks, is characterized by a point-type precision attack on scattered rogue missiles.

The seven anti-attack attack modules mentioned above use the intelligent priority combination attack mode, which can be operated independently or combined and run in parallel to form the full coverage and anti-missile of the front, launch, climb, and mid-range. At the same time as the anti-missile air-to-ground aircraft attacking the launched missiles and missile launchers, it can also be combined to attack it, that is related targets of supporting missile such as aircrafts, satellites, ships, radars and other such as reconnaissance, guidance, and data link transmission of the rogue missile, in order to completely systematically destroy the entire rogue missile attack's system.

### BRIEF DESCRIPTION OF THE DRAWINGS

The invention will now be described, by way of example, with reference to the accompanying drawings, in which:

FIG. 1A illustrates a perspective view of an exemplary airborne space anti-missile system, showing a supersonic jet operational in space and delivering an anti-missile at a launching missile from a first anti-missile module, a second anti-missile module, and a third anti-missile module, in accordance with an embodiment of the present invention;

FIG. 1B illustrates a perspective view of an airborne space anti-missile system, showing a supersonic anti-missile system delivering an anti-missile at a launching missile form a fourth anti-missile module and a fifth anti-missile module, in accordance with an embodiment of the present invention;

FIG. 2 illustrates a perspective view of an exemplary airborne space anti-missile system with the wings deployed to a forward position, in accordance with an embodiment of the present invention;

FIG. 3 illustrates perspective view of the airborne space anti-missile system shown in FIG. 3, showing the wings retracted to a rearward swept position, in accordance with an embodiment of the present invention;

FIG. 4 illustrates perspective view of the airborne space anti-missile system shown in FIG. 2, showing the wings partially deployed forward to the forward position, in accordance with an embodiment of the present invention;

FIG. 5 illustrates perspective view of the airborne space anti-missile system shown in FIG. 3, showing the wings partially retracted to the rearward swept position, in accordance with an embodiment of the present invention;

FIG. 6 illustrates perspective view of the airborne space anti-missile system shown in FIG. 2, showing the jet in cruise mode while the wings are retracted to the rearward swept position, in accordance with an embodiment of the present invention;

FIG. 7 illustrates perspective view of the airborne space anti-missile system shown in FIG. 2, showing the jet in cruise mode and the wings in the forward position, in accordance with an embodiment of the present invention;

FIG. 8 illustrates perspective view of the airborne space anti-missile system shown in FIG. 3, prior to launching the anti-missile with the wings retracted to the rearward swept position, in accordance with an embodiment of the present invention;

FIG. 9 illustrates perspective view of the airborne space anti-missile system shown in FIG. 2, prior to launching the anti-missile with the wings in the forward position, in accordance with an embodiment of the present invention;

FIG. 10 illustrates an example of the wing movement mechanism shows that when the servo motor rotates, the drive worm drives the turbine to rotate, and the turbine is fixed on the wing, thereby achieving a step less change of the wing angle, in accordance with an embodiment of the present invention;

FIGS. 11A and 11B illustrate views of an exemplary, it is an example of the partial structure of the anti-missile module and the wing stealth fusion, the structure of the anti-missile module itself is invisible, and it is not necessary to store it in the sealed bomb chamber, but it is completely exposed and embedded in the wing, and with the wing as a whole, in appearance, there is no visible stealth anti-missile attack module on the wing, where FIG. 11A shows the anti-missile module retracted into the wing, and FIG. 11B shows the anti-missile module bounce and extend out the wing, in accordance with an embodiment of the present invention;

Like reference numerals refer to like parts throughout the various views of the drawings.

### DETAILED DESCRIPTION OF THE INVENTION

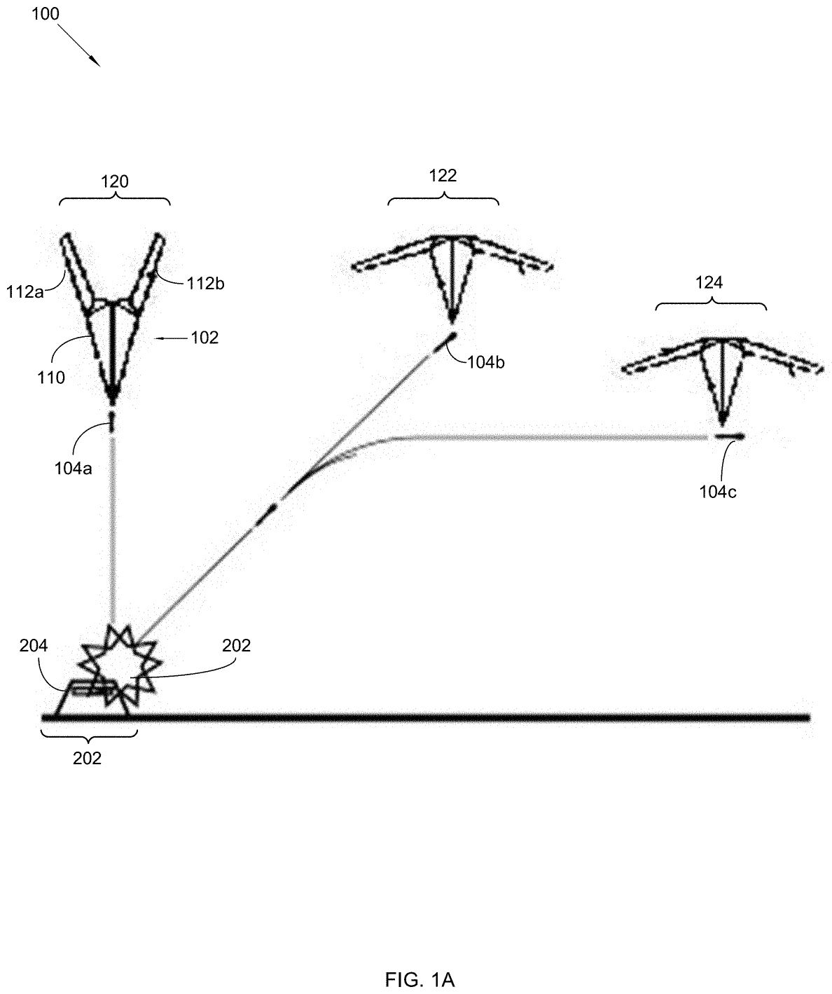

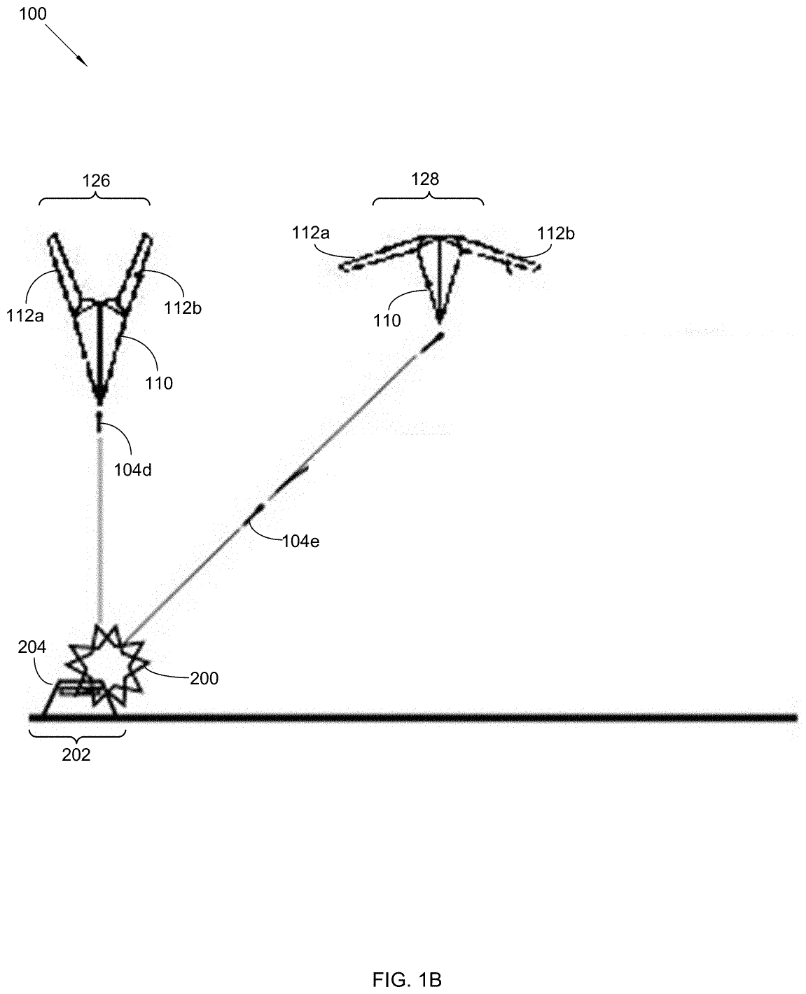

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1A. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An airborne space anti-missile system 100 is referenced in FIGS. 1A-11B. The airborne space anti-missile system 100 provides an offensive, non-passive means to target and destroy a launching missile 200 from the thermosphere (space) or the lower atmospheres, before the attacking missile is launched from a launch site 202. The system 100 is effective in infiltrating an anti-missile 104a behind enemy lines in a stealth manner from space, so as to identify and destroy various types of attacking missiles and their carrier 204, whether the launch site 202 is underground, on the ground surface ground, underwater, on the water, in the air, or even in the thermosphere (space). Specifically, the system 100 is effective in delivering the anti-missile 104a in the airspace of the front of the launch of the launching missile 200, so that the attacking missile is directly destroyed in the head of the launcher, rather than in the territory of the system.

The airborne space anti-missile system, provides a primary function of carrying out three levels of cap style vertical anti-ballistic missiles. The first level includes a search and reconnaissance search destroys land-based missile launch bases and their carriers and support systems, sea-based missiles and their carriers.

The second level includes an integrated reconnaissance search to destroy airborne missiles within 500 km above ground surface, with the focus on destroying supersonic glide missiles whose flight trajectory is on the Qian Xuesen trajectory; Intercontinental missiles flying outside.

A third level of the airborne space anti-missile system is to conduct an integrated search and reconnaissance search on the enemy's space weapons to destroy or reverse control. The further combat improvement of airborne space anti-missile system is mainly the function of destroying the directed energy weapon system.

As FIGS. 1A and 1B show, the system 100 provides a supersonic jet 102 to deliver the anti-missile 104 from the thermosphere (space). The supersonic jet 102 is offensive in nature, and flies at a very high speed of at least 10 times the speed of an ultra-high speed jet. This high speed allows the supersonic jet 102 to effectively deliver an air-to-surface missile from space towards the launch site 202 (ground or sea) of an attacking missile. The potentially launching missile 200 is targeted prior to launching from a launch site or during flight, so that it does not explode over a population center.

The anti-missile supersonic jet can cruise on the edge of the Earth's atmosphere, can also fly to outer space, and also cruises through the atmosphere. The anti-missile supersonic jet will utilize its ramjet infused engine when it enters into the atmosphere and will utilize the “nuclear plasma engine” when it enters into the space. More advanced second-generation anti-missile airplane in the future will use a smaller anti-material injection vector engine, which, in theory, will allow the supersonic jet to cruise in space for up to 50 years.

In some embodiments, the supersonic jet 102 is operational in seven different anti-missile modules that address the variations in type and launch sites used by the launching missile 200. In one non-limiting embodiment, the guidance for the air-to-surface missile fired by the supersonic jet 102 may be through at least one of the following: laser guidance, infrared guidance, optical guidance, or satellite guidance signals, gravitational wave guidance, quantum entanglement imaging guidance.

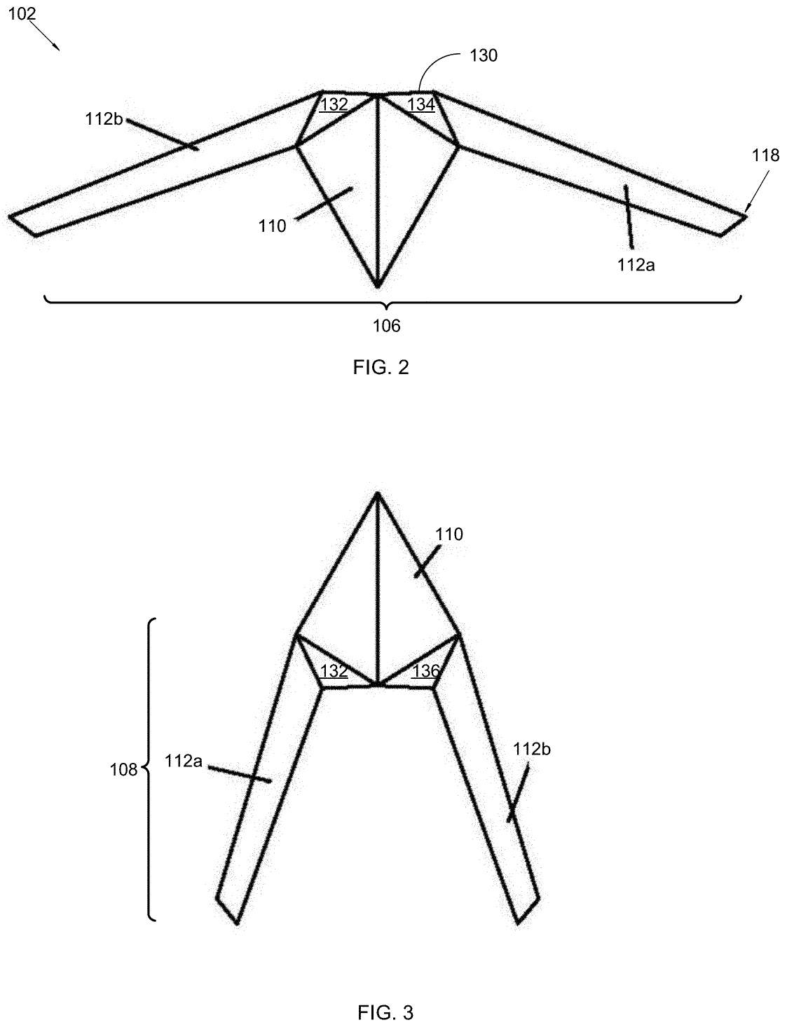

Turning now to FIG. 2, the supersonic jet 102 is defined by a unique, multi-configurable body type that enhances speed, space deployment, and stealth operations while flying in space. In one non-limiting embodiment, the supersonic jet 102 comprises a fuselage 110 and a pair of wings 112a, 112b that are adapted into a variable swept wing configuration that helps adapt to high speeds and high elevations (into the thermosphere, or space). The fuselage 110 of the supersonic jet 102 has a length of about 60 meters, a body height of about 15 meters. In one embodiment, the fuselage 110 of the supersonic jet 102 may utilize a sealed cabin. Further, the supersonic jet 102 has no vertical tail or rudder. This helps to reduce air drag during flight.

As FIG. 3 shows, the supersonic jet 102 utilizes unique power generation means. In one embodiment, the supersonic jet 102 comprises a nuclear plasma jet engine 132 that is operational in the thermosphere (FIG. 2). The supersonic jet 102 further comprises a stamping jet fusion vector engine 134 or an anti-material vector engine 136 for flying in the lower atmospheres (FIG. 3). For example, when the supersonic jet 102 is out of the atmosphere using a stamping jet fusion engine, but when the supersonic jet 102 is flying in the thermosphere, the nuclear plasma jet engine 132 is used. Thus, even if the anti-missile 104a-e is not deployed, the supersonic jet 102 uses its high speeds, high elevation, high mobility, and high awareness to avoid surface to air missiles and other anti-aircraft weapons known in the art.

However in other embodiments, the supersonic jet 102 may use a stamping jet fusion vector engine and nuclear power plasma composite jet vector engine, its uninterrupted cruise in space can be as long as three decades. However, in a more advanced future second-generation anti-missile air and sky plan, the supersonic jet 102 is powered by a smaller anti-material injection vector engine, in theory, its uninterrupted cruise in space for up to 50 years.

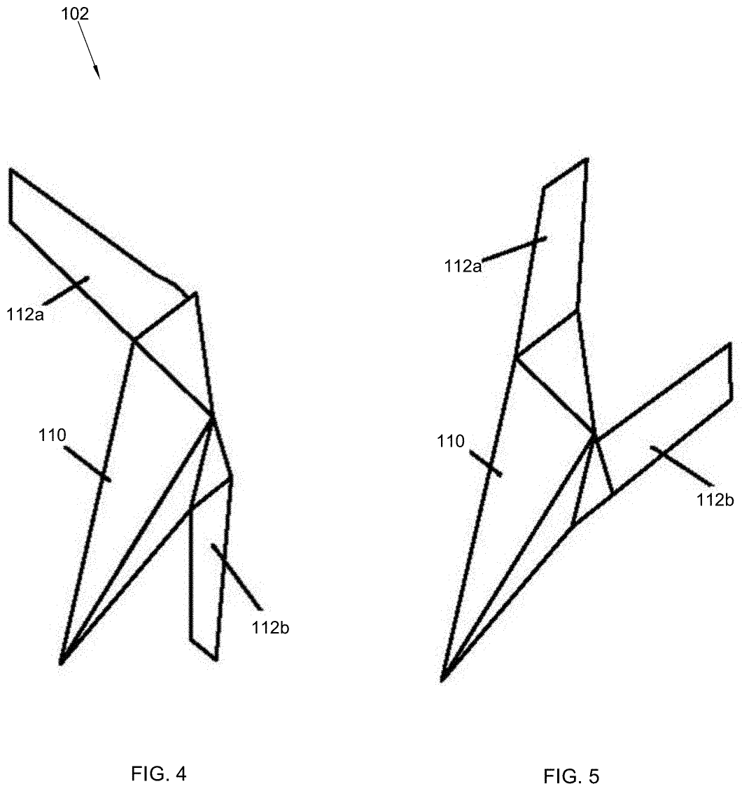

In some embodiments, the wings 112a, 112b of the supersonic jet 102 have a pointed wing structure 118 that is operable. The wings 112a-b are also adaptable to operate in the variable swept wing configuration. In this configuration, the wings 112a-b sweep forwardly and rearward at a range of about 100° range of wing positions (FIGS. 4 and 5). The supersonic jet 102 retracts the swept wing inward and rearward to reduce the air resistance during flight. The change in wing position is a step less change in angles, where the variable swept wing is controlled by the computer intelligent control to meet the command task requirements, speed, flight space environment adaptability control.

As FIG. 2 illustrates, a forward position 106 of the wings 112a-b moves the wing forwardly, such that the wingspan from the fuselage 110 is about 200 meters. And as FIG. 3 illustrates, a full rearward swept position 108 of the wings 112a-b retracts the wings so that the wingspan is reduced to minimize wind drag during flight. In the rearward swept position 108, the wings extend about 60 meters from the fuselage 110. Furthermore, the supersonic jet 102 utilizes electromagnetic space that enable stealth operations beyond enemy lines, which enhances delivery of the anti-missile 104.

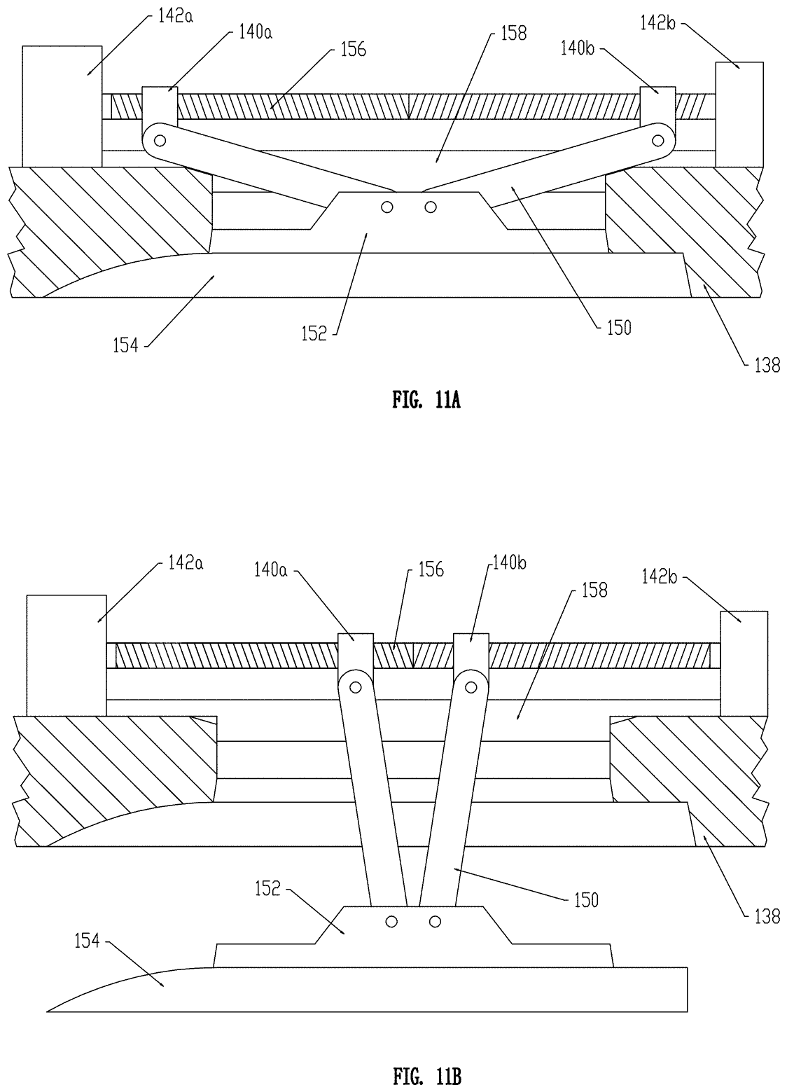

FIGS. 11A and 11B illustrate a partial cross-sectional schematic view of the stealth integration of the combat sub-module 154 and the wing 138 of the anti-missile attack module. The structure of the combat sub-module 154 of the anti-missile attack module is invisible and does not need to be stored in the sealed bomb chamber. The exposed and embedded 154 is integrated with the wing 138. From the appearance, it cannot be seen that there is a combat sub-module 154 of the anti-missile attack module on the wing 138.

FIG. 11A is cross-sectional view, FIG. 11A shows that the combat sub-module 154 of the anti-missile attack module is invisible fusion with the airframe 138. The mirror-symmetrical precision ceramic ball screw 156 has both left-handed and right-handed threads, half of the ball screw 156 is left-handed thread and half is right-handed thread. When the precision intelligent servo motor 142a rotates clockwise, it brings about symmetry. The precision ceramic ball screw 156 rotates, and the symmetrical precision ceramic ball screw 156 drives the nut sliders 140a and 140b to move in opposite directions along the guide rails 158. The nut sliders 140a and 140b drive the mirror-symmetrical link 150, and the link 150 pulls up. The combat sub-module 154 stealth pylon 152, the stealth pylon 152 drives the combat sub-module 154 to be embedded in the wing 138, to realize the stealth fusion of the combat sub-module 154 and the wing 138, and to realize the overall evasion through local stealth.

As shown in FIG. 11B shows, a partial cross-section illustrating that the combat sub-module 154 enters an attack state. When the IntelliSense attack instruction is executed, the precision intelligent servo motor 142a rotates counterclockwise at a high speed to drive the symmetrical precision ceramic ball screw 156 to rotate at a high speed, and the symmetrical precision ceramic ball screw 156 drives the nut sliders 140a and 140b to be opposite each other along the guide rail 158. Moving, the nut sliders 140a and 140b drive the mirror-symmetrical connecting rod 150, and the connecting rod 150 promptly ejects the stealth hanger 152, and the stealth hanger 152 instantly places the combat sub-module 154 in an attack state.

Looking back at FIGS. 1A and 1B, the supersonic jet 102 is operational in seven different modules 120, 122, 124, 126, 128, with each module being operational to target a different type and launch site 202 of the launching missile 200 prior and after launching from the launch site 202. These seven intelligent anti-missile modules are optimized to activate system 100 operation, and are determined based on the attack state. The anti-missile modules include: a smart fly swarms surface anti-missile module, a high-energy temperature and pressure cloud explosion anti-missile module, a tungsten-tantalum-hafnium alloy anti-missile module, an electromagnetic pulse anti-missile module, an outer ion tube anti-missile module, a kinetic missile anti-missile module, a anti-missile module of the superconducting laser system.

As FIG. 1A references, a first anti-missile module 120 is a kinetic energy drill anti-missile module. The first anti-missile module 120 is used mainly for targeting larger launching missile targets. The first anti-missile module 120 may utilize a tungsten-tantalum-hafnium alloy. The first anti-missile module is a kinetic energy drill anti-missile module, that is, the front anti-missile module, mainly for large targets.

The first anti-missile module 120 is mainly used in the launch of the attacking missile attack instantaneous, that is, the front, anti-missile airborne aircraft found large-scale launch of the attacking missile group, follow the launch of the missile to the attacking missile, launch base, launch cave and other targets on the earth, condescending More than 300 times the sound tungsten-tantalum-hafnium alloy kinetic energy drilling missiles, the implementation of vertical “cap” attack, high-speed kinetic energy drill to the ground when the impact of the explosion is exactly the same as the meteorite landing effect. This produces high temperature, high heat explosion shock wave, and lead to local small underground earthquakes.

As FIG. 1A illustrates, a second anti-missile module 122 is an atmosphere temperature and pressure cloud detonation anti-missile. The second anti-missile module 122 is operational against medium sized targets. The second anti-missile module 122, the atmosphere temperature and pressure cloud detonation anti-missile module. The second anti-missile module 122 is mainly used in the launch of the attacking missile instantaneous, that is, the front, anti-missile 104a-e aircraft found and locked the attacking missile. The second anti-missile module 122 is effective in locking onto the attacking missile launch site 202, such as ground missile silos, launchers, submarines, ships.

In one unique embodiment of the second anti-missile module 122, the attacking missile launch platform condescends to deliver temperature and pressure cloud bombs, and also the implementation of vertical “cap” attack, temperature cloud explosion bomb is divided into two levels. The first level into the attacking missile trajectory climbing channel, the moment off, and broken distribution cloud explosives, and aerosol into a high concentration of air cloud, dense in the attacking missile to climb the ballistic area, the attacking missile through the air group, the tail flame will detonate the air group, the attacking missile must be completely destroyed. At the same time, level direct flight to the attacking missile launch platform. The explosion effect can be various types of ground small and medium-sized missile launch platform device completely destroyed.

A third anti-missile module 124 is an electromagnetic pulse anti-missile module. The third anti-missile module 124 is used to target attacking missiles that have been launched and are in flight. The third anti-missile module 124, the electromagnetic pulse anti-missile module, the middle of the anti-missile module. When the attacking missile slip into the middle of the flight, the anti-missile aircraft lock onto the launching missile 200 to apply a high-power electromagnetic pulse on the launching missiles 200 while they are in flight. This creates precise attacks, so that the attacking missile control system 100 lines and chips are destroyed by electromagnetic pulse.

The anti-missile attack module of the superconducting laser system is integrated in 124 yet, it is mainly applicable to attacking and destroying ballistic missiles and Qian Xuesen's trajectory missiles outside the atmosphere. The working mechanism is that the superconducting laser system only needs to aim at the target missile and fire the laser at an instant, which can cause irreversible damage to the external structure of the missile. When the damaged missile re-enters the atmosphere, it is inevitably at high temperatures. Extend from the damage, it is destroyed by the height heat.

The superconducting laser system is made of superconducting materials and does not bring huge heat to the system, which can ensure stable operation of the laser weapon system and antimissile module.

That is, the superconducting laser system anti-missile attack module, which is mainly used for mid-course anti-missile attacks, is characterized by a point-type precision attack on scattered missiles.

Continuing with the modules in FIG. 1B, a fourth anti-missile module 126 is an atmosphere outside the ion gun anti-missile 104a-e attack module. The fourth anti-missile module 126 is used to target attacking missiles that have been launched and are in flight. In one embodiment of the fourth anti-missile module 126, an Anti-Air Space Shuttle from the solar wind is used to collect unlimited ion “ammunition”. Thus, when the launching missile 200 is outside the atmosphere, the middle, anti-missile air and sky to keep locked the attacking missile, with ion guns with high energy ion beam on the flight of attacking missiles. The implementation of precision strikes, the huge kinetic energy of the ion beam and the heat of transformation will destroy the attacking missiles. At the same time, the ion gun also creates special ionic forces to effectively destroy the launch of attacking missiles from space-day mobile platform, such as: satellites, spacecraft, space stations and the like.

Looking now at FIG. 1B, a fifth anti-missile module 128 is a kinetic missile anti-missile 104a-e attack module. The fifth anti-missile module 128 is used to target attacking missiles that both, have not yet been launched, and that have been launched and are in flight. The fifth anti-missile module 128 is also used to target a launch platform. The fifth anti-missile module 128, kinetic missile anti-missile module is used for both for the end of the anti-missile 104a-e, but also for the front anti-missile.

In operation, when the launching missile 200 is in flight in the atmosphere, it will inevitably produce a lot of infrared light. The anti-missile 104e uses airplane precision to lock onto the launching missile 200. The kinetic missile high-speed impact of the launching missile 200 is then completely destroyed. At the same time, the kinetic energy missile also attacked the launch of the missile consisting of metal objects constitute a mobile platform, such as: submarines, warships, aircraft carriers, trains, trucks, aircraft and so on.

The smart fly swarms surface attack module is include in missile 200 yet, this anti-missile mode is to carry out the destroy attack on the surface of the rogue missile launching position (including the vehicle-mounted missile), and its working mechanism is such that the smart flies are assembled in the mini in stealth missiles, under the guidance of the guidance and self-identification of the fly's eye system, from the anti-missile spacecraft, the mini stealth missiles secretly and accurately approach the target area. In the airspace near the surface of several hundred meters, the smart fly is removed from the mini. Invisible missiles are released. In addition to the fly-eye pattern recognition capability, the smart fly has a more olfactory perception capability. The smart fly's olfactory ability is extraordinary. It can sensitively perceive the propellant of the missile propulsion department, and even the pharmacy of the warhead, the battery of the control unit, and can be summarized. The first generation of smart flies mainly used the cluster attack mode. After entering the enemy missile position, the smart fly group, the intelligent identification group, flew to each enemy's missile body, and attacked the three key parts of the missile, that is, the target of the attack was the missile warhead, control department (including gyroscopes, computers, batteries, etc.), propellant propellants, etc. The smart flies are attacked by a percussive attack. That is, the smart fly flies to the missile at high speed, and the missile immediately explodes on contact with the missile. It shows high efficiency and does not give any time to the enemy. The smart fly swarm will be different direction in this way and any angle launches a cluster suicide attack on the missile. When a smart fly is found close to an enemy missile hiding in a cave or a missile silo and cannot perform a percussive attack, it has two choices: When it hides itself for a moment, it waits for opportunities to opportunistically attack. The second is to call antimissiles. Air-to-sky aircraft launches a tungsten-germanium alloy kinetic energy bomb that performs a destructive attack. That is, the smart fly swarm surface attack module is mainly used for the anti-missile attack before the rogue missile launch. It is characterized by the most suitable minimally surgical way anti-missile attack before launch.

The above seven kinds of anti-missile modules 120, 122, 124, 126, 128 utilize intelligent priority combination of attack mode, either alone, or in a combined and parallel operation. The formation of the attacking missile launch stage, climb stage, the middle of the flight, the last flight full coverage and complex attack anti-missile 104a-e. While supersonic jet 102 deploys the anti-missile 104 at the launching missile 200 and missile launch carrier 204 at the same time. The modules can also support the attacking missile attack detection, guidance, data transmission and other related purposes, such as aircraft, ships, radar and other groups to implement a combination of attacks, to completely systematically destroy the entire launching missile, or network of launching missiles.

Turning now to FIG. 10, the supersonic jet 102 further comprises a flying lens or a Hawkeye intelligent composite system 130 that allow the supersonic jet 102 to capture images of the launch site 202 and surrounding air space with a unique camera system. In one embodiment, the flying lens or the Hawkeye intelligent composite system 130 is operable to capture a panoramic image of the launch site 202 or the surrounding air space. The flying lens or the Hawkeye intelligent composite system 130 is operable to monitor a six-dimensional cutting surface environment. This may include a piece of film, once a piece of intelligent opening, the various anti-missile module of the intelligent operation conditions can be generated, and thus into the elimination of offensive missiles and support system 100 model.

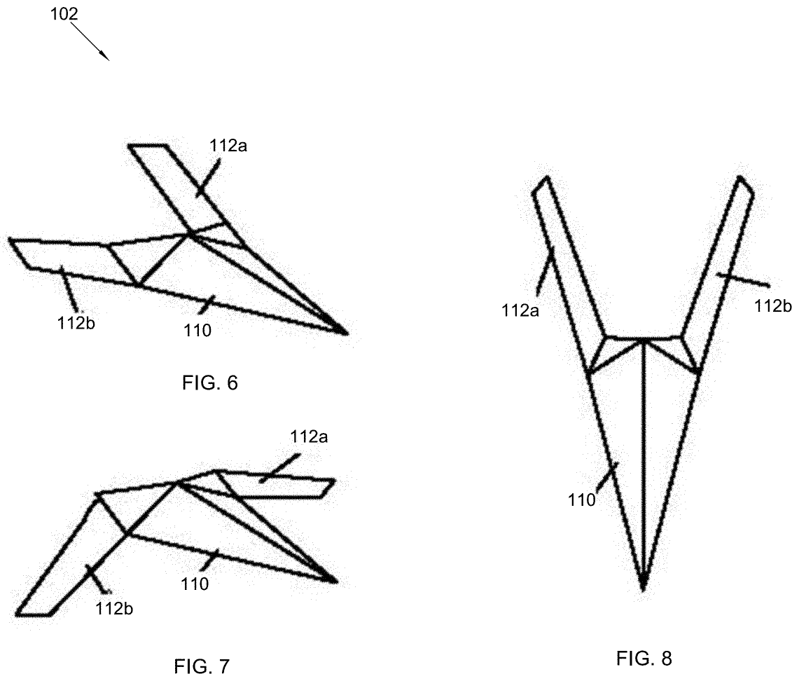

In one embodiment shown in FIG. 6, the flying lens or the Hawkeye intelligent composite system 130 comprises an arm 138 that extends from one of the wings 112a-b or the fuselage 110. The arm terminates at a terminal end 134. A hinge member 136 at the terminal end 134 enables a camera arm 132 to automatically pivot and rotate the flying lens or a Hawkeye intelligent composite system 130 to capture a desired image. In this manner, the pilot, or a remote piloting system, controls manipulation of the flying lens or a Hawkeye intelligent composite system 130.

Turning to FIG. 7, the supersonic jet 102 may further include electromagnetic waves, gravitational waves, quantum cloud coherent spectrum of intelligent fusion detection search integration system. This system is combined into a long-range Hawkeye search system and close the fly eye detection search system. The detection and tracking positioning tracking are effective for controlling accuracy to reach the order of millimeters, including stealth missiles, including all kinds of missiles cannot escape. In yet another embodiment, the supersonic jet 102 may utilize a sealed cabin.

In use, as shown in FIG. 8, when the anti-aircraft airplane into the Earth theater plate, then start the Hawkeye system and fly eye system to implement complex detection. When the target distance of 10 kilometers or less, the main use of short-range flies eye system to implement the detection of anti-missile 104a-e. When the target distance is 10 kilometers away, the main use of remote Hawkeye system to implement the detection of anti-missile integrated search. At the same time, the supersonic jet 102 with the ground warning system, airborne early warning system, space warning system trinity of the data link sharing system, follow the sense of locking onto targets anywhere on Earth.

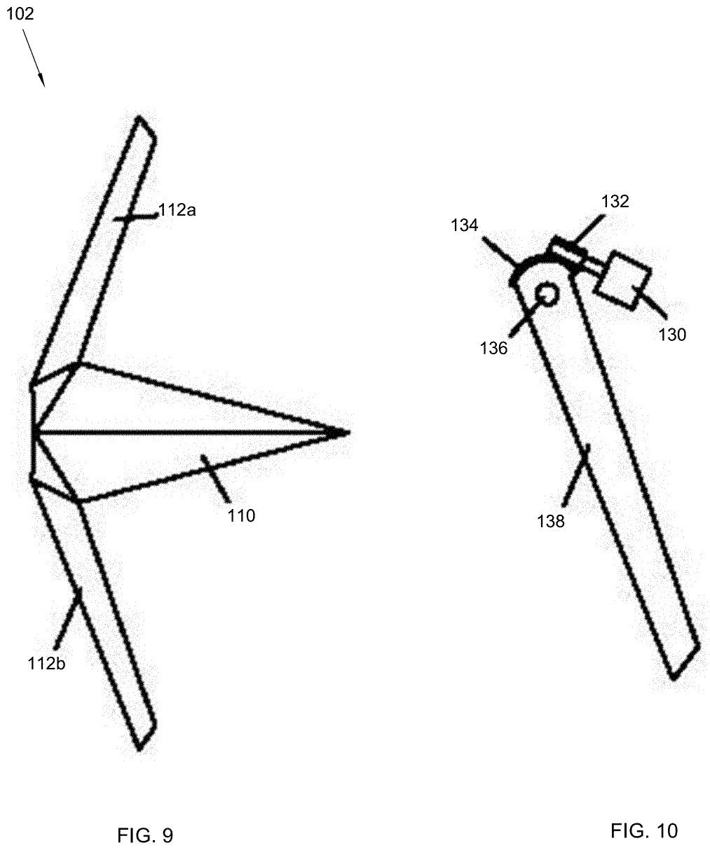

The supersonic jet 102 is operational in a normal cruise mode that is effective for maintaining the smart integration. The normal cruise mode can maintain the supersonic jet 102 at a silent cruise flight, including the infrared wavelengths and a variety of adaptive wavelengths of the radar immediately activated to start intelligent integration detection (FIG. 9). This helps begin transformation of the anti-missile system 100 into the anti-missile 104a-e attack state.

In some embodiments, the supersonic jet 102 may be equipped with intelligent long-arm manipulator, if necessary, to capture space assets from the attacking force. The supersonic jet 102 may further implement reverse transformation, so that the attacking force lost the attacking missile attack the real support system. This works to paralyze the launching missile's true offensive ability to achieve war and the purpose of subdue the soldiers.

Further, the supersonic jet 102 may include an intelligent fusion detection and recovery system based on electromagnetic waves, gravitational waves and quantum cloud coherent spectra. In one alternative embodiment, a next generation supersonic jet will use a smaller volume of anti-material vector injection engine. In yet another alternative embodiment, an ultimate generation of supersonic jet 102 includes a universe dark energy power fusion vector engine. In this way, the supersonic jet 102 can fly at full speed, or be fully developed, so that it can be cruise for decades without interruption. This helps eliminate the threat of attacking missiles and protect the peace of mankind equipment.

As discussed above, the supersonic jet 102 used to deliver the anti-missile 104a-e from space is dynamic, using a stamping jet fusion vector engine and nuclear power plasma composite jet vector engine, its uninterrupted cruise in space can be as long as three decades. However, in a more advanced future second-generation anti-missile 104a-e air and sky plan, the supersonic jet 102 is powered by a smaller anti-material injection vector engine, in theory, its uninterrupted cruise in space for up to 50 years.

In this way, the supersonic jet 102 not only solves the problems of the front anti-missile 104a-e, but also effectively controls the launching missile 200 and deters other attacking forces, eliminates attacking missiles, serves as the guardian of human justice and democracy, liberates special space equipment, and is a strong cornerstone to defense.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

Airborne space anti-missile system is equipped with an intelligent fusion reconnaissance and strike-attack system based on electromagnetic waves, gravitational waves, and quantum cloud coherence spectrum, and is integrated into a long-range Hawkeye reconnaissance system and a close-range fly eye reconnaissance system. Its reconnaissance, tracking, positioning, and locking control accuracy can reach millimeters, making it impossible for missiles, including stealth missiles, to be shaped.

At the same time, airborne space anti-missile system is mainly operated by the intelligent central quantum computer built in. It can be integrated into a panoramic image through intelligent fly-eye and Hawkeye intelligent compound systems, and it can be used to monitor and monitor the environment of six-dimensional planes. The outer layer has a high-temperature resistant stealth absorbing and dissipating particle clip. Once the intelligent opening of the clip, the intelligent operating conditions of various anti-missile modules can be generated, thereby entering the attack mode of eliminating the rogue missile and its supporting system.

As shown in FIGS. 1, 2, 3, and 4, Airborne space anti-missile system is characterized in that its outline is a pointed flying wing structure with no vertical tail and rudder, and the body 110 has a length of 60 meters. 110 with a height of 15 meters and two variable swept wings 112a and 112b with two infinitely variable 100 degrees range, forward full unfolding of the variable swept wing 112a and 112b. The wingspan of the straight state is 200 meters, and the full sweep wingspan of the variable sweep wings 112a and 112b is fully retracted backwards to 60 meters.

The schematic diagram of the wing movement mechanism shown in FIG. 9 illustrates the wing 138 as an example. The wing 138 is provided with a sector worm wheel 134. The sector worm wheel 134 meshes with the worm 132 when the servo motor 130. When rotating, the worm 132 is driven to rotate synchronously, and the worm 132 drives the sector worm wheel 134 to rotate around the axis 136, that is, the motive wing 138 rotates to realize swept wing transformation.

FIG. 11A and FIG. 11B are schematic diagrams illustrating the partial structure of stealth fusion of invisible anti-missiles model block 154 and wings 138. This disclosure is mainly to facilitate the description of the stealth of anti-missile spacecraft as a whole, stealth anti-missiles model block 154. The structure itself is invisible, and it is not necessary to store it in the sealed chamber. It is completely exposed and embedded in the wing 138 and merges with the wing 138. From the outside, it is impossible to see the wing 138, there are stealth anti-missiles model block 154.

As shown in the partial cross-sectional view of FIG. 11A, the symmetrical precision ceramic ball screw 156 has both left-handed and right-handed threads that is, mirrored symmetrically in the center. Half of the screw is left-handed and half is right-handed. When the motor 142a rotates clockwise, the symmetrical precision ceramic ball screw 156 rotates, and the symmetrical precision ceramic ball screw 156 drives the nut slider 140a and 140b along the guide rail 158. In reverse rolling, the nut sliders 140a and 140b drive the mirror-symmetrical linkage 150, the connecting rod 150 pulls the take-off stealth pylons 152, and the missile stealth pylons 152 drive stealth anti-missiles model block 154 embedded wing 138 to achieve the precision fusion of the anti-missile model block 154 and the wing 138, to achieve local stealth and overall hiding.

As shown in the partial sectional view of FIG. 11B, when sensing the time of attack, the precision intelligent servo motor 142a rotates counter-clockwise at high speed, driving the symmetrical precision ceramic ball screw 156 to rotate at high speed, and the symmetrical precision ceramic ball screw 156 is driven again. The nut sliders 140a and 140b slide along the guide rail 158 in opposite directions at high speed. The nut sliders 140a and 140b drive the mirror-symmetrical linkage 150, and the connecting rod 150 rapidly pops out. Missile stealth pylons 152 instantaneously place stealth anti-missiles model block 154 in attack launch status.

For a brief explanation of stealth anti-missiles model blocks 154, first of all, there are many varieties of bombs of stealth anti-missiles model blocks 154. Here are just three examples:

### Example 1

When implementing the smart fly group surface attacking module method, multiple guided miniature stealth missiles are embedded in the stealth missiles 154 that are fired (subsequently issued by the sub-patent of this patent for further description) to enter the airspace ideal altitude, Mini stealth missiles pop up, two acceleration flights, close to the ground, the mini stealth missiles decelerate, and open intelligent release smart fly, that is, the smart fly group surface attack module enters the final attack destroy phase.

### Example 2

When implementing the high-energy temperature and pressure cloud explosion anti-missile attack module method in the atmosphere, multiple guided high-energy temperature-pressure cloud explosion bombs are nested inside the launched stealth missile 154 (subsequently published sub-patent of this patent), the stealth missile 154 enters the ideal height of the airspace of the theater, and intelligently releases the high-energy temperature-pressure cloud bomb, and the high-energy temperature-pressure cloud bomb pops up. That is, the high-energy temperature-pressure cloud explosion anti-missile attack module enters the final attack destruction state.

### Example 3

When implementing the smart dexterity high-speed invisible missile anti-missile attack module method, multiple guided missiles with smart dexterity and high-speed stealth missiles are embedded in the stealth missiles 154 that are launched (sub-patents of this patent will be further described), stealth missiles 154 enter the ideal height of the airspace of the theater, open intelligent smart ultra-high-speed stealth missiles, intelligent smart high-speed stealth missiles pop up, accelerate secondary relays at high speed, intelligently lock rogue missiles, carry out attacks.

In the future, the anti-missile space-sky aircraft will be equipped with defensive and destructive means for directed energy weapons. Its operating mechanism is: when the anti-missile space-sky aircraft enters the theater, the aircraft with flying sub-discharge can be released. The principle is based on the Nikola Tesla discharge principle. When the enemy's directed energy weapon system emits attack energy, the discharge aircraft will be intelligently triggered. In addition to directly destroying the enemy's directed energy, it will obey the enemy's directed energy transmission channel and perform reverse attack to destroy the enemy's directed energy weapon. System, like continuous lightning, the effect is the formation of anti-matter annihilation effect.

In the future, anti-missile space-sky aircraft will become the real king of warfare. It is not only the terminator of ballistic missiles, but also the weapon of the air vehicle that destroys of the rogue regime in a condescending manner. It can effectively attack the ground targets of rogue regimes.

In short, the emergence of anti-missile spacecraft will eventually become the decisive force for curbing the rogue regime, and it will enable the rogue missiles to withdraw from the arena of history and become the ultimate weapon to determine the outcome of war. It will contribute to the preservation of human freedom and dignity.

What is claimed is:

1. An airborne space anti-missile system, the system comprising:
an anti-missile; and
a supersonic jet being operable to launch the anti-missile at an attacking missile, the supersonic jet comprising a nuclear plasma jet engine operational in the thermosphere, the supersonic jet further comprising a stamping jet fusion vector engine or an anti-material vector engine for flying in an atmospheric layer lower than the thermosphere,
the supersonic jet further comprising a fuselage having a length of about 60 meters and a height of about 15 meters,
the supersonic jet further comprising a pair of variable swept wings articulating in a 100° range of wing positions, the wings including a forward position where the wings are fully forward and a wingspan extends about 200 meters from the fuselage, and a full rearward swept position where the wingspan retracts to about 60 meters from the fuselage.

2. The system of claim 1, wherein the supersonic jet flies in the thermosphere or space, at about 10 times the speed of an ultra-high speed jet.

3. The system of claim 1, wherein the variable swept wings comprise a pointed wing structure.

4. The system of claim 1, wherein the supersonic jet is not operable with a vertical tail or a rudder.

5. The system of claim 1, wherein the supersonic jet is operational in seven modules, each module operational to target a different type of attacking missiles prior and after launching from a launch site.

6. The system of claim 5, wherein the seven modules comprise a first anti-missile module, the first module being the smart fly swarms surface attack anti-missile module.

7. The system of claim 6, wherein the first anti-missile module is operable against missile before launch.

8. The system of claim 5, wherein the seven modules comprise a second anti-missile module, the second module being an atmosphere temperature and pressure cloud detonation anti-missile.

9. The system of claim 8, wherein the second anti-missile module is operable against large area targets.

10. The system of claim 5, wherein the seven modules comprise a third anti-missile module, the third anti-missile module being a kinetic missile anti-missile.

11. The system of claim 10, wherein the third anti-missile module is operable against the attacking missile that has been launched and is in flight.

12. The system of claim 5, wherein the seven modules comprise a fourth anti-missile module, the fourth module being a W—Ta—Hf kinetic energy drill land anti-missile module.

13. The system of claim 12, wherein the fourth anti-missile module is operable against large targets.

14. The system of claim 5, wherein the seven modules comprise a fifth anti-missile module, the fifth anti-missile module being an electromagnetic pulse anti-missile.

15. The system of claim 14, wherein the fifth anti-missile module is operable against the attacking missile that has been launched and is in flight.

16. The system of claim 5, wherein the seven modules comprise a sixth anti-missile module, the sixth anti-missile module being an atmosphere outside the ion gun anti-missile.

17. The system of claim 16, wherein the sixth anti-missile module is operable against the attacking missile that has been launched and is flying outside the atmosphere.

18. The system of claim 5, wherein the seven modules comprise a seventh anti-missile module, the seventh anti-missile module being anti-missile attack module of the superconducting laser system

19. The system of claim 18, wherein the seventh anti-missile module is operable against the attacking missile that has been launched and is in flying outside the atmosphere.

20. An airborne space anti-missile system, the system consisting of:
an anti-missile;
a supersonic jet being operable in the thermosphere, or space, to launch the anti-missile at an attacking missile, the supersonic jet comprising a nuclear plasma jet engine operational in the thermosphere, the supersonic jet further comprising a stamping jet fusion vector engine or an anti-material vector engine for flying in an atmospheric layer lower than the thermosphere,
the supersonic jet further comprising a fuselage having a length of about 60 meters and a height of about 15 meters,
the supersonic jet further comprising a pair of variable swept wings articulating in a 100° range of wing positions, the wings including a forward position where the wings are fully forward and a wingspan extends about 200 meters from the fuselage, and a full rearward swept position where the wingspan retracts to about 60 meters from the fuselage,
whereby the variable swept wings comprise a pointed wing structure;
at least one motor driving the variable swept wings between the rearward swept position and the forward position;
a pair of mounts stabilizing the variable swept wings during motion;
whereby the supersonic jet is operational in seven modules, each module operational to target a different type of attacking missiles prior and after launching from a launch site, the seven modules comprising:
a first anti-missile module, the first module being a kinetic energy drill anti-missile module;
a second anti-missile module, the second module being an atmosphere temperature and pressure cloud detonation anti-missile;
a third anti-missile module, the third anti-missile module being an electromagnetic pulse anti-missile;
a fourth anti-missile module, the fourth anti-missile module being an atmosphere outside the ion gun anti-missile;
a fifth anti-missile module, the fifth anti-missile module being a kinetic missile anti-missile;
a sixth anti-missile module;
a seventh anti-missile module;
an intelligent fusion detection and recovery system based on electromagnetic waves, gravitational waves and quantum cloud coherent spectra; and
a flying lens or a Hawkeye intelligent composite system, the flying lens or the Hawkeye intelligent composite system being operable to capture a panoramic image, the flying lens or the Hawkeye intelligent composite system further being operable monitor a six-dimensional cutting surface environment.
